(19) United States
(12) Patent Application Publication
(10) Pub. No.: US 2005/0194330 A1
(43) Pub. Date: Sep. 8, 2005

(54) Storage device and system

(76) Inventor: Ann Marie Ziske, Lewiston, NY (US)

Correspondence Address: William J. Crossetta, Jr.;Crossetta & Associates, 905 Convention Towers, 43 Court Street, Buffalo, NY, 14202, US

(21) Appl. No.: 10/888,235

(22) Filed: Jul. 12, 2004

Related U.S. Application Data
(60) Provisional application No. 60/549,968, filed on Mar. 5, 2004.

(51) Int. Cl. B42F 1/00

(52) U.S. Cl. 211/59.1

(57) ABSTRACT

A storage system is disclosed comprising an elongate “C” channel member, mounting means for slidably mounting support fixtures to the channel member, and a variety of support fixtures comprising a base plate and supporting elements, the base plate arranged for mounting the fixture to the mounting means and the supporting elements arranged to support articles to be stored by the storage system.

### TECHNICAL FIELD

The present invention relates to storage systems and devices, particularly article suspension storage systems and devices which can be removably mounted to walls, studs, ceilings and the like to provide convenient suspended storage of a plurality of diverse articles. This application claims the benefit of Provisional Application 60/549,968 filed Mar. 5, 2004.

### BACKGROUND OF THE INVENTION

Various types of devices and systems have been devised and are used to store, display and/or suspend items from walls and ceiling, but all generally suffer from common attributes of being limitative in convenience, dislodging failure, flexibility of use and the type of articles that can be stored thereby.

In one common storage system, a pegboard having an organized plurality of holes is mounted to a wall and formed hooks are provided alone or with fixtures and the like which can be removably inserted through one or more holes in the pegboard to support the fixture and/or articles supported by the fixture. Generally such system is limited to use in generally vertical installations, and is inconvenient in that the pegboard must be mounted spaced from the wall to enable insertion of supporting hooks, with the hooks and fixtures supported by such hooks being held in place by their own weight and/or the weight of the article they are supporting. Such systems are generally subject to failure with the curved hooks being easily dislodged when jostled as for example when an article is removed or moved, pegboard is generally not suitable for supporting heavy articles, and reliance upon hole placement in the pegboard generally limits the flexibility of its use.

In another common storage system, vertically oriented metal “U” shaped channel members are attached to a wall or the like with the opening of the “U” facing the wall, and the closed interconnecting end of the “U” facing outwardly with a vertical row of spaced, vertically slotted openings along its length. The slotted openings are arranged to accepted mating hooked ends of supporting brackets which can be mounted to the channel members to support shelving at various fixed positions. Such systems generally are limited to use for mounting shelf brackets and require very careful alignment of widely spaced mounted pairs of vertical members to assure level shelving. The fixed vertical arrangement of mounting positions is not generally suitable for eclectic spacing for the suspended storage of diverse items.

U.S. Pat. No. 6,449,608 discloses a similar wall mounted storage system, wherein the open side of a “U” shaped channel member is horizontally mounted facing a wall or the like, and the closed connecting side of the “U” channel member comprises two or more vertically spaced and horizontally oriented rows of aligned vertically slotted openings forming a web portion to which mating hooked ends of storage attachments can be mounted at fixed positions to support items. As with the prior system, the fixed mounting positions are not generally suitable for eclectic spacing in the hanging storage of items.

### SUMMARY OF THE INVENTION

The present invention pertains to a storage device and system which generally comprises an elongate “C” channel member arranged for mounting to a supporting structure such as a wall, support studs, ceiling or the like; means for removably and slidably mounting support fixtures to said channel member; and, a variety of unique support fixtures which can be mounted to the channel member to enable unique customized, off-the-floor storage of a variety of items of different size shape and character.

By elongate “C” channel member, is meant an elongate member having a hollow channel along its length with a longitudinal slot forming an opening to the hollow. The width of the slot is less than the width of the hollow, such that in a cross-section of the channel member, the slotted hollow channel appears as a general “C” shaped hollow.

“C” channel members of the invention include generally curve (e.g. rounded) formed “C” shaped elongate hollow(s), generally polygonal (e.g. four or more sided) formed “C” shaped elongate hollow(s) and generally triangular (e.g. three sided) formed “C” shaped elongate hollow(s), with the opening of the “C” being an elongate slot along the length of the member, opening to the exterior of the channel member. The “C” channel member of the invention can contain a single or plurality of hollows and one or more of the hollows can comprise slots forming one or more generally “C” shaped hollow(s), with slots facing in the same or different directions. Thus in one embodiment the “C” channel member comprises a single hollow with a single elongate slot comprising a “C” shaped hollow. In another embodiment the elongate channel member comprises one or more interior cross-members forming two or more hollow channels, one or more comprising elongate slots forming generally “C” shaped hollows. In a preferred embodiment, a cross-member forms two oppositely facing, generally polygonal, generally “C” shaped hollow channels. In another preferred embodiment cross-members form three, four or more generally triangular formed hollows having interior connecting apexes, with one or more of the hollows comprising an elongated slot opening to form one or more triangular formed “C” shaped hollow(s). In the latter embodiment, it is generally preferred that the interior angle formed at the intersection of the interior crossing members be rounded and the exterior surface of the member be polygonal. It should be understood however the exterior surface of the member may round, oblong or curved, hollow channels therein may be pie or the like shaped, and a channel member may comprise two or more spaced generally “C” shaped hollows arranged facing a common direction, opposite directions and/or other different directions.

Generally, a closed side of a single hollow, generally “IC” shaped channel member comprises openings spaced along the closed length of the hollow channel arranged to enable mounting of the channel to a supporting structure such as wall, studs, ceiling or the like. In a preferred embodiment such mounting openings are arranged opposite the slot. In embodiments comprising opposite facing “C” shaped hollow channels, spaced openings are generally arranged through interior cross-members and/or along the convergence of cross-members of the various triangulated channel members to enable passage of a fastening means such as a screw, nail or the like for mounting of the channel member to a wall, studs, ceiling or the like. In one preferred embodiment a channel member comprises interior cross members forming four hollow “C” shaped channels facing at right angles to each other with attachment screw holes through the apex of the crossing members enabling attachment of the channel member to free standing studs and enabling mounting of fixtures in four different directions. Thus for example a fixture(s) can be mounted extending a first direction from the studs, other fixtures extending from the opposite direction, and fixtures extending downwardly and upwardly from a single channel member. In still another embodiment the elongate channel member comprises a plurality of “C” shaped hollow channels with slots along a common plane enabling attachment of fixtures at different heights along a common vertical plane.

The elongate channel member can be formed from any suitable material, such as durable plastic, metal, combinations thereof and the like, and can comprise any appropriate finish and/or coating, including painted, plastic coatings, deposit coatings and the like. In a preferred embodiment the channel is formed from extruded metal, preferably extruded aluminum or alloys thereof, and most preferred anodized aluminum or alloys thereof.

Mounting means are generally arranged to slidably mount the storage fixture to variable fixed positions along the elongate slot of the channel member. Any suitable means for slidably mounting the storage fixture to the channel member may be used which engages the interior of the hollow and resists movement of the fixture along the channel when arranged at a position.

In one embodiment, mounting means comprise expandable means which engage the storage fixture and comprise an end enabled to engage opposing interior walls of the channel member to resist movement of the fixture along the channel. Such means include but are not limited to spring grip means, screw expansion means, cam expansion means and the like, arranged to force surfaces of the mounting means against opposing surfaces of interior walls of the “C” channel to resist movement from a fixed position.

In a preferred embodiment the mounting means comprises clamping means, arranged to engage the interior and exterior surface of the sides of the “C” channel adjacent the slot in clamping engagement to resist movement of a connecting support fixture from a fixed position. In a particularly preferred embodiment the mounting means comprises screw (bolt) and nut clamping means. Any suitable mating screw and nut means may be used as mounting means, and either the screw head or the nut may be arranged within the hollow of the “C” channel. In embodiments wherein the nut is to be arranged within the hollow it is generally preferred the nut be sized so it naturally rests with its threaded hole convenient for mating engagement with a screw. In such embodiments speed nuts and/or blocks and/or rods with a threaded hole providing improved surfaces to engage interior surfaces of the channel and enable convenient mating with the screw are particularly preferred.

Generally it is preferred that the head of the screw be arranged within the interior of the “C” channel and the body of the screw be sized to loosely insert through the slot to enable convenient sliding movement of the screw to a desirable fixed position within the channel member and resist falling out. The head of the screw comprises a fastening surface arranged to engage the interior surface of the channel adjacent the elongate slot. When the channel member comprises a rounded generally “C” shaped cross-section, the fastening surface of the head of the screw is preferably curved to mate with a generally curved interior surface of the channel member adjacent the elongate slot. When the channel member comprises a generally polygonal or triangular “C” shaped member the fastening surface of the head of the screw is generally flat to mate with a generally flat interior surface of the channel member.

The head of the screw can be of any convenient shape, polygonal, oval, round or the like. In one embodiment wherein the generally “C” shaped channel is generally polygonal “C” shaped, the head is preferably polygonal. In another embodiment wherein the generally “C” shaped channel member is triangulated to a general “C” shape, the head is preferably round and has a curved top surface. In a particularly preferred embodiment, the head of the screw has a curved top surface, while the body of the screw, adjacent the head, is polygonal, preferably about square, with the remaining portion of the body of the screw being threaded. The polygonal portion of the screw is arranged to ride along the straight edge of the slot in the channel member and it is preferred that the depth of the polygonal portion be about the same as the thickness of the metal sides forming the slot, the screw commonly being referred to as a carriage bolt. In a particularly preferred embodiment the fastening surface of the head of the screw comprises one or a plurality of concentric ridges, to reduce the actual surface of the head casually engaging the interior surface of the chamber and enable convenient sliding of the screw along the interior surface along the length of the channel member when not under clamping tension, while providing greater impression gripping of the tightened screw to the interior surface under compression tightening.

Generally a hole is provided in a base plate of the support fixture through which the body of the screw can connect and threaded nut means is provided to be threaded on the screw to fasten the base plate to a desirable fixed position along the channel member. In a preferred embodiment, threaded nut means comprises a convenient levered gripping means to enable tool free tightening of the nut on the screw. In one preferred embodiment, levered gripping means comprises a threaded hand wheel, preferably comprising knobs, studs or the like extending from the circumference to enable convenient hand grip tightening.

The invention contemplates a wide variety of different support fixtures, each of which comprise a base plate, storage means and an optional support spacer. As previously noted the base plate comprises one or more holes through which mounting means can be inserted to mount a fixture to the channel member. If the support fixture is intended to support storage of large or awkward items, two or more holes may be spaced from each other in the base plate to enable use of two or more mounting means to improve rigidity or strength of the mounting. Thus for example a support fixture comprising a hook or arms for supporting an article hanging therefrom might only need a single hole for mounting to a “C” channel member, while a supporting fixture comprising a plurality of bins fastened to an elongate base plate may have a plurality of holes along its length for mounting to the “C” member.

In a preferred embodiment a base plate generally comprises a support spacer arranged to engage the surface of the wall or the like to which the channel member is attached.

The support spacer is generally sized to maintain the base plate of the fixture generally about parallel to the wall, ceiling or the like to which the channel member is mounted, and comprises structure sized to generally extend from the base plate a distance corresponding to about the depth of the elongate channel member. Such spacer is arranged so that when the base plate is fixed to the elongate channel member, the support spacer can engage the wall, stud, ceiling or the like to which the elongate channel is mounted, and provide added support to the support fixture to prevent it from angularly twisting under the weight of an item that is being supported thereby. Such spacer can be fixed, adjustable, removable and can be made of any suitable material. In a preferred embodiment, the support spacer is formed into an end of the base plate spaced from the attachment hole(s).

The support fixture may comprise various different supporting means. In many embodiments, the supporting means comprises one or a plurality of support bars, such as flat or cylindrical rods or arms, which extend from the base plate and/or have hooks, bends or the like arranged to engage various common items for storage. For example a single hook or bar may extend from the base plate for supporting ropes, extension cords or engaging a hole or loop at the end of a tool handle. In other embodiments, a storage means can comprise various racks for storage of footwear or brooms or slots and the like for supporting a single or multi-drawer storage bin or the like. In other embodiments, a storage means can comprise a particular device configured for storing skis or snow-boards, or comprise an elongated base plate having one or more holes, studs, bolts or the like for attachment of one or more common items such as multi-drawer chests, cabinets or the like.

In one embodiment a support fixture comprises a base plate having extending outwardly therefrom a utility hook. In another embodiment a support fixture for tools comprises a base plate having extending about perpendicular therefrom two spaced generally parallel rods with ends bent upwardly to enable hanging rakes, shovels and the like with their working ends up. In still another embodiment, a support fixture for lawn trimmers comprises a lower utility hook extending outwardly from the base plate and a rod extending perpendicular from the base plate ending in a “U” configuration. In a still further embodiment, a support fixture comprises a wire rack attached parallel to the base plate comprising a plurality of curved loops for supporting footwear such as shoes, boots and the like. In a still further embodiment a rod is pivotally hinged to a base plate at one end and at the opposite end comprises an offset extended “U” form, to enable gravitational grasping within it of one or more elongate elements, such as a handle, board, skis and the like in suspended storage. In yet another embodiment a rod is pivotally hinged to a base plate at one end and at the opposite end comprises an offset loop, to enable the gravitational grasping within it of a one or more elongate elements such as a handle, board, skis, snow board and the like in suspended storage.

### BRIEF DESCRIPTION OF THE DRAWINGS

FIG. 1 is a partial sectional, exploded perspective view of one embodiment of the invention.

FIG. 1A is a partial sectional perspective view of the FIG. 2 is an exploded perspective view of another embodiment of the invention.

FIG. 2A is a reverse perspective view of the embodiment of the invention of FIG. 2.

FIG. 3 is an exploded perspective view of a further embodiment of the invention.

FIG. 4 is an exploded perspective view of another embodiment of the invention.

FIG. 5 is an exploded perspective view of still another embodiment of the invention.

FIG. 6 is an exploded perspective view of a further embodiment of the invention.

FIG. 7 is a perspective view of a another further embodiment of the invention.

FIG. 7A is a reverse perspective view of the embodiment of the invention of FIG. 7.

FIG. 8 is a perspective view of a further embodiment of the invention.

FIG. 9 is a perspective view of a still further embodiment of the invention.

FIG. 10 is a perspective view of another embodiment of the invention.

FIG. 11 is a perspective view of a further embodiment of the invention.

FIG. 11A is a side plan view of the embodiment FIG. 11.

FIG. 12 is a perspective view of a still further embodiment of the invention.

FIG. 13 is a front plan view of a bin fixture of the invention.

FIG. 13A is a side plan view of the bin fixture of FIG. 13.

### DETAILED DESCRIPTION OF THE DRAWINGS

At the outset, it should be clearly understood that like reference numerals are intended to identify the same structural elements, portions or surfaces consistently throughout the several drawing figures as such elements, portions or surfaces may be further described or explained by the entire written specification, of which this detailed description is an integral part. Unless otherwise indicated, the drawings are intended to be read together with the specification, and are to be considered a portion of the entire written description of this invention.

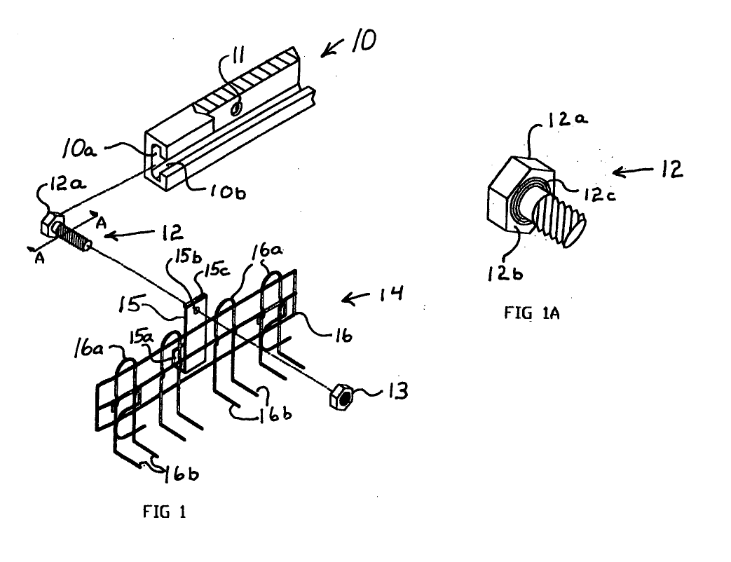

FIG. 1, illustrates an embodiment of the invention wherein elongate channel member 10 is illustrated as comprising a single interior hollow channel 10a, with slot 10b providing access thereto. Hole 11 is illustrated as arranged on the closed wall of hollow channel 10a for fastening channel member 10 to a supporting stud, wall, ceiling or the like (not shown), by screw or the like fastener. The illustrated support fixture mounting means is shown as comprising bolt 12 having a polygonal head 12a arranged and sized to slidably insert into interior channel 10a and resist removal through slot 10b by engaging the interior surface of the sides forming the slot. Support fixture 14, comprises base plate 15 having integral support spacer 15a, mounting hole 15b, plate alignment guide 15c and support structure 16. Support fixture 14 is mounted to a fixed position on bolt 12 along channel member 10 by nut 13, with a surface of support spacer 15a engages the stud, wall or the like to which channel member 10 is mounted while plate alignment guide 15c engages an edge of the channel member to retain the support fixture in preferred alignment with the channel member. Support structure 16 of support fixture 14 is a wire formed structure, welded or otherwise attached to base plate 15 and comprises a plurality of loops 16a arranged to fit within the toe area of footwear, while paired support bars 16b are arranged to support the heels of such footwear.

FIG. 1A illustrates concentric ridges 12c arranged on the interior clamping surface 12b of head 12a of bolt 12 of FIG. 1. This embodiment is particularly suitable for resisting movement of the mounted fixture along the channel member in arrangements wherein the channel member is mounted angularly, particularly vertically.

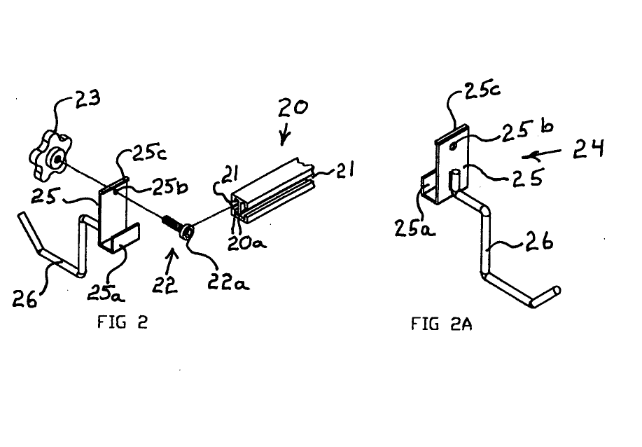

FIGS. 2 and 2A illustrate an embodiment of the invention wherein elongate “C” channel member 20 has two opposite facing polygonal hollow channels 20a with corresponding slots 21 providing access thereto. This channel member is particularly suitable for installations wherein a plurality of widely spaced vertical studs are arranged generally within a common plane to enable support of the member and it is desired to attach support fixtures to opposite sides of the channel member. Bolt mounting means 22 comprises a round head 22a, arranged and sized to slidably insert into interior channel 20a, and resist removal through slot 21. Support fixture 24, comprises base plate 25 having integral support spacer 25a, mounting hole 25b, plate alignment guide 25c and support structure 26. Support fixture 24 is mounted to bolt means 22 in a fixed position along channel member 20 by wheel nut means 23, with a surface of support spacer 25a engaging the stud, wall or the like to which channel member 20 is mounted and plate alignment guide 25c engaging an edge of the channel member. Support structure 26 of support fixture 24 comprises a wire formed structural hook, welded or otherwise attached to base plate 25.

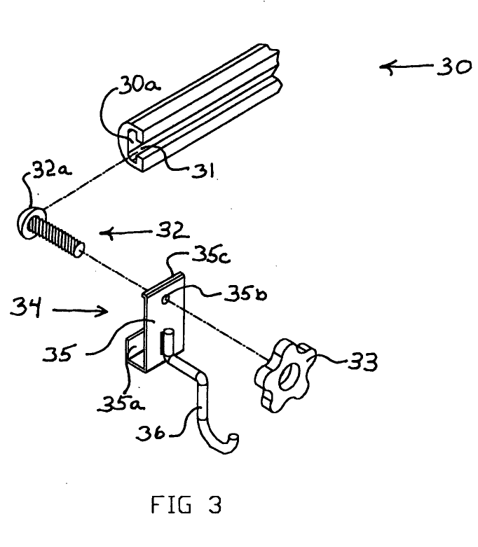

FIG. 3 illustrates an embodiment of the invention wherein elongate curved “C” channel member 30 has a single hollow “C” channel 30a with slot 31 providing access thereto. Bolt mounting means 32 comprises a round head 32a arranged and sized to slidably insert into interior channel 30a, and resist removal through slot 31. Support fixture 34, comprises base plate 35 having integral support spacer 35a, mounting hole 35b, plate alignment guide 35c and support structure 36. Support fixture 34 is mounted to a fixed position along channel member 30 by wheel nut means 33, with a surface of support spacer 35a engaging the stud, wall or the like to which channel member 30 is mounted. Support structure 36 of support fixture 34 comprises a wire formed structural hook, welded or otherwise attached to base plate 35.

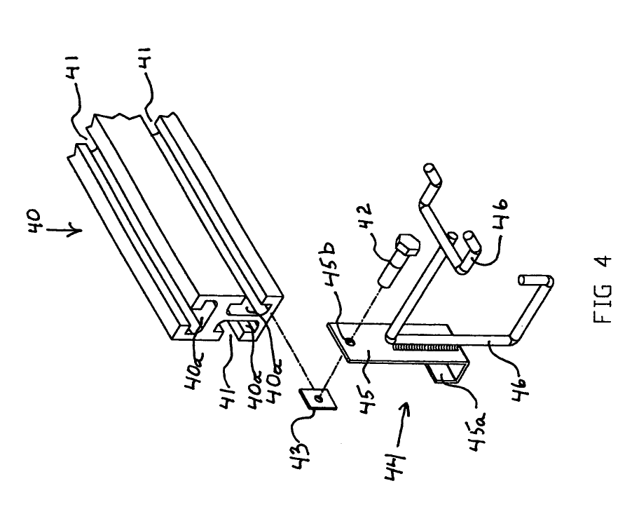

FIG. 4 illustrates an embodiment of the invention wherein elongate channel member 40 has a three polygonal hollow “C” channels 40a, with slots 41 providing access thereto. This channel member is particularly suitable for use when mounting to a ceiling or the like wherein it is desirable to mount fixtures both horizontally and vertically from the channel member. Mounting means comprises a flat speed nut 43 is arranged and sized to slidably insert into an interior channel and resist removal through the slot from the interior channel. Support fixture 44, comprises base plate 45 having integral support spacer 45a, mounting hole 45b and support structure 46. Support fixture 44 is mounted to a fixed position along channel member 40 by screw means 42, with a surface of support spacer 45a engaging the stud, wall or the like to which channel member 40 is mounted. Support structure 46 of support fixture 44 comprises a wire formed “U” shaped hook, welded to base plate 45 and arranged to support an elongate motorized lawn trimmer.

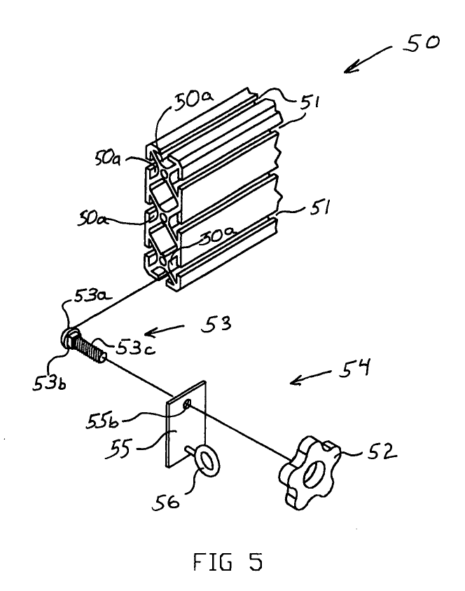

FIG. 5 illustrates an embodiment of the invention wherein elongate channel member 50 has a plurality of generally triangular hollow “C” channels 50a, with slots 51 providing access thereto. Such channel member generally enables the attachment of horizontally, vertically and angularly arranged support fixtures through a plurality of different heights and provides increased support rigidity. Mounting means is illustrated as comprising a carriage bolt 53 arrangement, having a curved round head 53a, a generally square shaft 53b adjacent head 53a, with the remaining shaft 53c being threaded. The generally square portion of the bolt is arranged to ride along the straight edge of a slot in the channel member and the depth of the square portion is sized about the same as the thickness of the metal sides forming the slot. Support fixture 54, comprises base plate 55 having mounting hole 55b with support structure 56 comprising a common eye bolt arrangement. Support fixture 54 is mounted to a fixed position along channel member 50 by wheel handle nut means 52.

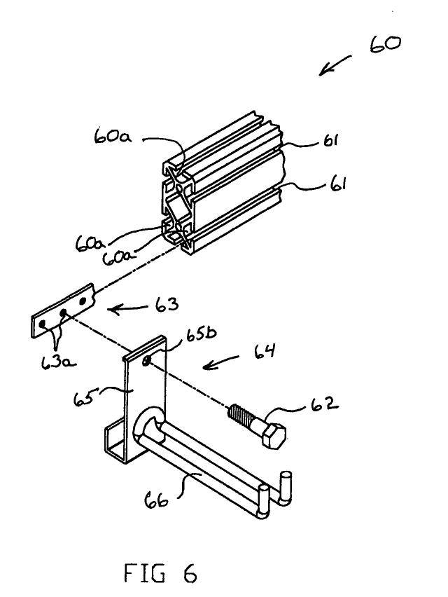

FIG. 6 illustrates an embodiment of the invention wherein elongate “C” channel member 60 has a plurality of generally triangular interior “C” channels 60a, with slots 61 providing access thereto. In this embodiment mounting means is illustrated as comprising an elongate flat rod 63 with spaced threaded openings 63a therethrough. Support fixture 64, comprises base plate 65 having mounting hole 65b with support structure 66 comprising two generally parallel rods extending therefrom to support a tool such as a shovel head on an elongate handle. Support fixture 64 is mounted to a fixed position along channel member 60 by common bolt means 62.

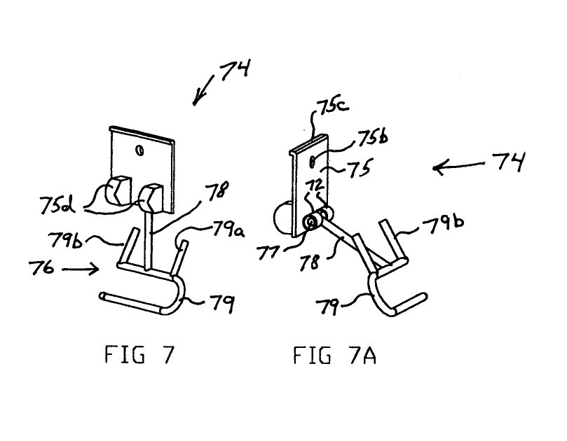

FIGS. 7 and 7A illustrate a ski supporting embodiment of a support fixture of the invention wherein support fixture 74, comprises base plate 75 having mounting hole 75b, plate alignment guide 75c, support spacers 75d and support structure 76. Support spacers 75d are illustrated as polymeric bumpers attached to the mounting surface of base plate. Support structure 76 comprises a pivot hinge arrangement illustrated as comprising spaced aligned pintle bearings 72 welded or otherwise connected to base plate 75 with pintle 77 rotatably mounted therein having a near end of rod 78 rigidly “T” connected thereto enabling a remote end of rod 78 to pivotally rotate through an arc in respect to base plate 75. The remote end of rod 78 is illustrated as comprising an elongate “U” shaped guide 79 with spaced extensions 79a and 79b extending therefrom. Guide 79 and its extensions 79a and 79b are oriented at an angle to the plane of rod 78. In an orientation of support fixture 74 wherein base plate 75 is mounted about vertical along a channel member mounted to a wall, and rod 78 is arranged about horizontal, inserting one or more generally vertical skis into the “U” shaped guide with and pivoting the remote end of rod 78 downwardly locks the skis into a supported stored position, with extensions 79a and 79b comprising hooks over which ski poles can be looped for convenient stored support.

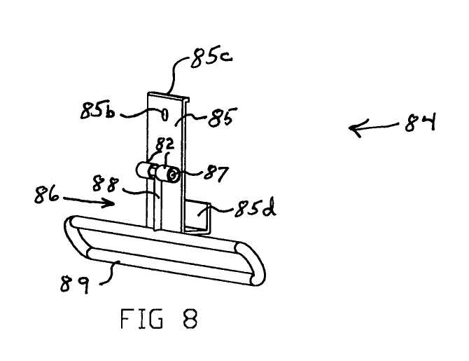

FIG. 8 illustrates a snow board supporting embodiment of a support fixture of the invention wherein support fixture 84, comprises base plate 85 having mounting hole 85b, plate alignment guide 85c, support spacer 85d, and support structure 86. Support structure 86 comprises a pivot hinge arrangement illustrated as comprising spaced aligned pintle bearings 82 welded or otherwise connected to base plate 85 with pintle 87 rotatably mounted therein having a near end of rod 88 rigidly “T” connected thereto enabling a remote end of rod 88 to pivotally rotate through an arc in respect to base plate 85. The remote end of rod 88 is illustrated as comprising an elongate loop guide 89. Loop guide 89 is oriented at an angle to the plane of rod 88. In an orientation of support fixture 84 wherein base plate 85 is mounted about vertical along a channel member mounted to a wall, and rod 88 is arranged about horizontal, vertically inserting a snow board into loop guide 89 and pivoting the remote end of rod 88 downwardly locks the snow board into a supported stored position.

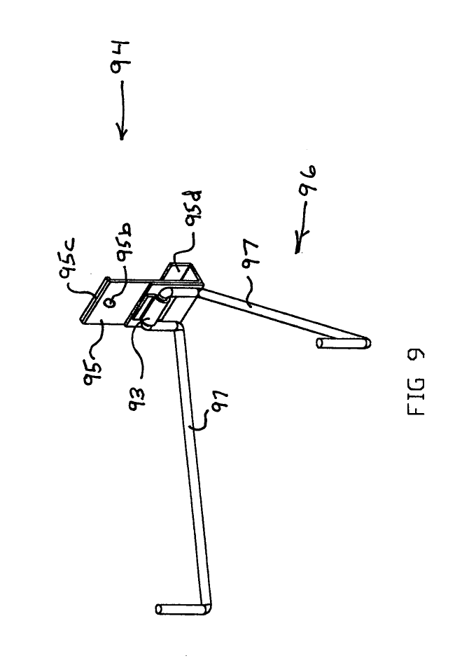

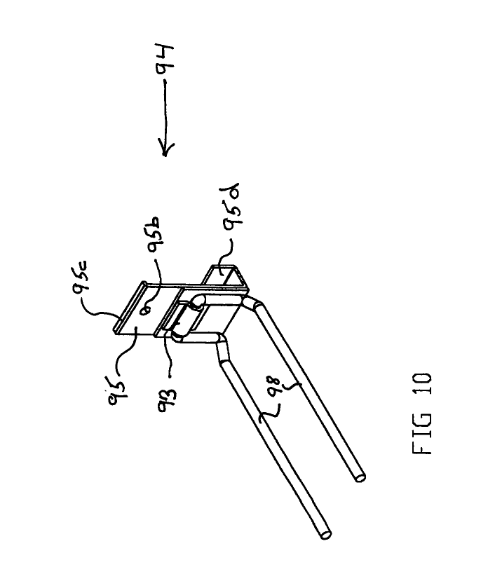

FIG. 9 illustrates an embodiment of a support fixture 94, comprising base plate 95 having mounting hole 95b, plate alignment guide 95c, support spacer 95d and support structure 96. Support structure 96 comprises a spred-legged rod 97, which is pivotally hinged to base plate 95 by overlap strap 93. FIG. 10 illustrates an embodiment of a support structure wherein generally parallel aligned legs of rod 98 are pivotally hinged to base plate 95 by overlap strap 93.

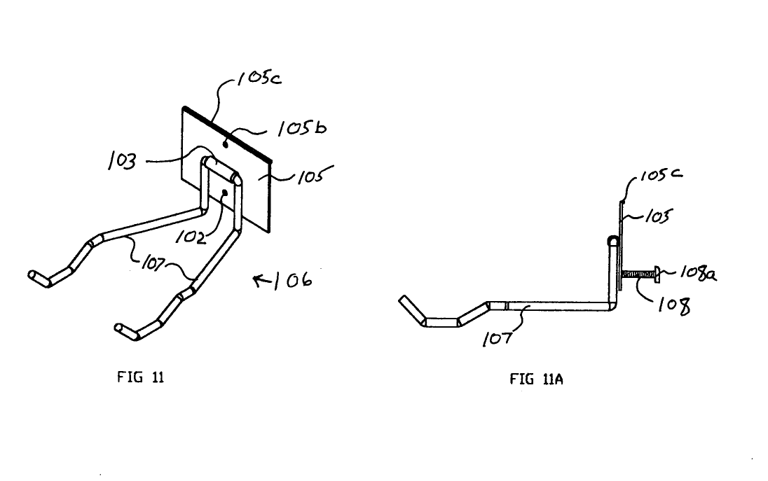

FIGS. 11 and 11A illustrate an embodiment of a support fixture 104, comprising base plate 105 having mounting hole 105b, plate alignment guide 105c, adjustable support spacer 105d and support structure 106. Support structure 106 comprises a spred-legged, cupped end rod 107, which is pivotally hinged to base plate 105 by overlap strap 103. The adjustable support spacer comprises threaded rod 108 having pivotable foot 108a thereon, the threaded rod screwing into mating threaded hole 102 in base plate 105.

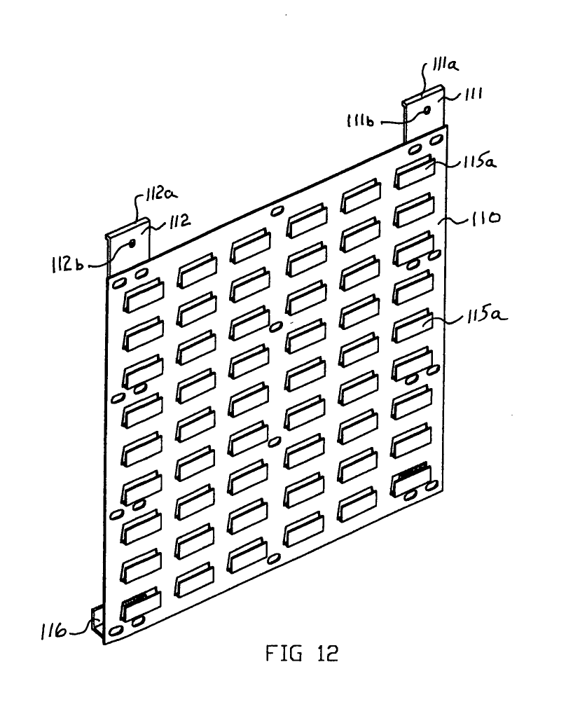

FIG. 12 illustrates an embodiment of a slotted base plate for mounting a plurality of bins and the like support structures in various arrangements to a “C” channel. In this embodiment, base plate 110 comprises a plurality of aligned raised “L” support tabs 115a, spaced base mounting tabs 111 and 112, and support spacer 116. Mounting tabs 111 and 112 comprise tab alignment guides 111a and 112a respectively and mounting holes 111b and 112b respectively. Alignment guides 111a and 112a are in alignment with each other and arranged to engage an edge of an elongate channel member, and when base plate 110 is affixed to the channel member through mounting holes 111b and 112b, retain base plate 110 in fixed alignment with the channel member.

“L” support tabs 115a, are arranged to accept mating one or more reversed “L” tabs contained on the rear surface of a supporting element such as a bin or the like.

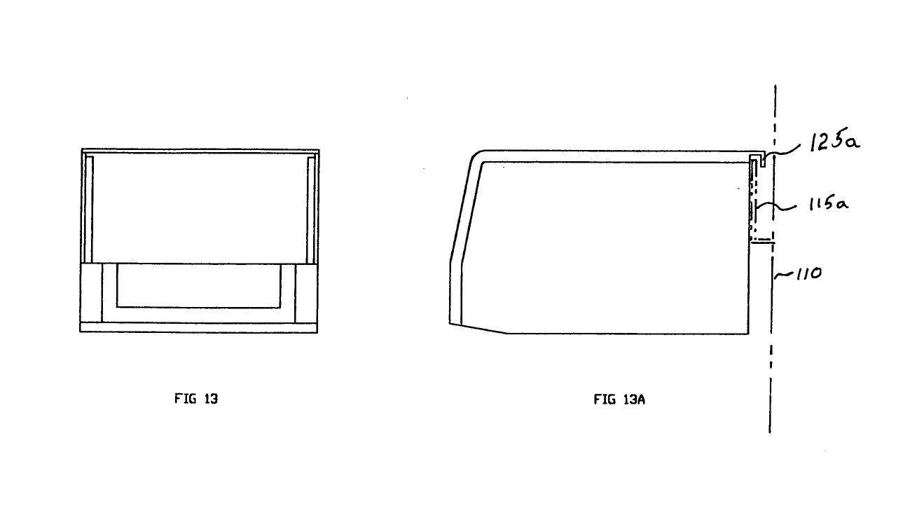

FIGS. 13 and 13A respectively, illustrate a front plan view and side plan view of an embodiment of a support bin comprising a mating arrangement of “L” tabs 125a for sliding engagement with tabs 115a, illustrated in phantom, of base plate 110 of FIG. 12. In a similar manner, an elongate drawer unit or the like can be provided with one or more reversed “L” support tabs for mating engagement with the “L” tabs 115a.

1. A storage device comprising: an elongate “C” channel member; mounting means for slidably mounting support fixtures to said channel member; a support fixture comprising a base plate and supporting element, said base plate arranged for mounting said fixture to said mounting means and said supporting element arranged to support articles to be stored thereby.

2. The storage device of claim 1 wherein said channel member is selected from generally curved, polygonal and triangular formed “C” shaped channel member.

3. The storage device of claim 1 wherein the channel member comprises one generally “C” shaped hollow channel therein.

4. The storage device of claim 1 wherein the channel member comprises at least one interior cross-member forming at least two generally “C” shaped hollow channels therein.

5. The storage device of claim 4 wherein a hollow channel formed in said channel member comprises a triangular formed “C” shaped channel member.

6. The storage device of claim 4 wherein a hollow channel formed in said channel member comprises a polygonal formed “C” shaped channel member.

7. The storage device of claim 1 wherein said mounting means comprises expandable means arranged to engage opposing interior walls of a hollow, slotted channel in said channel member, to resist movement of a fixture along said channel member.

8. The storage device of claim 7 wherein the expandable mounting means is selected from spring grip means, screw expansion means and cam expansion means.

9. The storage device of claim 1 wherein said mounting means comprises clamping means arranged to simultaneously engage the interior and exterior surfaces of a side adjacent a slot of a hollow slotted “C” channel member.

10. The storage device of claim 9 wherein said clamping means comprises bolt and nut mounting means.

11. The storage device of claim 10 clamping means comprises levered gripping means.

12. The storage device of claim 10 wherein said nut comprises a threaded wheel means.

13. The storage device of claim 10 wherein the head of said bolt comprises a wheel means.

14. The storage device of claim 10 wherein a fastening surface of the head of the bolt comprises a concentric ridge.

15. The storage device of claim 1 wherein the base plate of said support fixture comprises a support spacer arranged to retain said base plate at a supported position relative to the channel member.

16. The storage device of claim 15 wherein said support spacer is integrally formed at an end of said base plate.

17. The storage device of claim 15 wherein said support spacer is arranged for variable support depths.

18. The storage device of claim 1 wherein the base plate of said support fixture comprises a plate alignment guide.

19. The storage device of claim 1 wherein the base plate of said support fixture comprises a hole for mounting to said channel member.

20. The storage device of claim 1 wherein said support fixture comprises a supporting element selected from support bar and support hook, extending outwardly from the base plate arranged to engage an item for storage.

21. The storage device of claim 20 wherein said support bar comprises a rod pivotally connected to said base plate.

22. The storage device of claim 21 wherein said rod is configured to pivot from an outwardly extended supporting position to a non-supporting position in a plane proximate the plane of the base plate.

23. The storage device of claim 1 wherein said support fixture comprises a wire rack supporting element having curved loops arranged for supporting footwear.

24. The storage device of claim 1 wherein said support element comprises a rod pivotally hinged to the base plate at one end and an offset, angled “U” configuration at the opposite end, arranged to enable gravitational grasping of one or more elongate items in suspended storage.

25. The storage device of claim 24 wherein said opposite end of said rod comprises an offset, angled loop configuration arranged to enable gravitational grasping of one or more elongate items in suspended storage.

26. The storage device of claim 1 wherein the base plate of said support fixture comprises supporting means selected from slot, stud, threaded bolt, and “L” tab means.

27. A support fixture, comprising a base plate and supporting element, said base plate having means for mounting said support fixture to a supporting structure, and a supporting element arranged to support articles to be stored thereby.

28. The support fixture of claim 27 wherein the base plate comprises a support spacer arranged to retain said base plate at a supported position relative to the channel member.

29. The support fixture of claim 28 wherein said support spacer is integrally formed at an end of said base plate.

30. The support fixture of claim 28 wherein said support spacer is arranged for variable support depths.

31. The support fixture of claim 27 wherein the base plate of said support fixture comprises a plate alignment guide.

32. The support fixture of claim 27 wherein the base plate of said support fixture comprises a hole for mounting to a “C” channel member.

33. The support fixture of claim 27 wherein said support fixture comprises a supporting element selected from support bar and support hook, extending outwardly from the base plate arranged to engage an item for storage.

34. The storage device of claim 33 wherein a support bar comprises a rod pivotally connected to said base plate.

35. The support fixture of claim 33 wherein said rod is configured to pivot from an outwardly extended supporting position to a non-supporting position in a plane proximate the plane of the base plate.

36. The support fixture of claim 27 comprising a wire rack supporting means having curved loops arranged for supporting footwear.

37. The support fixture of claim 27 comprising a rod pivotally hinged to the base plate at one end and an offset, angled “U” configuration at the opposite end, arranged to enable gravitational grasping of one or more elongate elements in suspended storage.

38. The support fixture of claim 37 wherein said opposite end of said rod comprises an offset, angled loop configuration arranged to enable gravitational grasping of one or more elongate elements in suspended storage.

39. The support fixture of claim 27 wherein the base plate comprises supporting means selected from slot, stud, threaded bolt, and “L” tab means.

40. A method for the storage of articles, comprising:
providing an elongate “C” channel member enabled for mounting to a supporting structure and having an open slot to a hollow interior chamber of the channel member;
providing a support fixture, said support fixture comprising a base plate and supporting element, said supporting element arranged to support articles to be stored thereon;
providing means for slidably mounting said base plate of said support fixture through said open slot to said “C” channel member;
mounting said “C” channel member about horizontally to supporting structure;
slidably mounting said support fixture through said open slot to said “C” channel member and supporting an article with said supporting element.
